(19) United States
(12) Patent Application Publication
(10) Pub. No.: US 2004/0020612 A1
(43) Pub. Date: Feb. 5, 2004

(54) Ceiling actuator for up-and-over and sectional doors

(76) Inventor: Giuseppe Bosio, Castenedolo (IT)

Correspondence Address: MCGLEW & TUTTLE, PC, SCARBOROUGH STATION, SCARBOROUGH, NY, 10510, US

(21) Appl. No.: 10/629,047

(22) Filed: Jul. 28, 2003

(30) Foreign Application Priority Data
Jul. 31, 2002 (IT) BS2002U000092
Apr. 17, 2002 (IT) BS2003U000040

(51) Int. Cl. E05F 15/00

(52) U.S. Cl. 160/188

(57) ABSTRACT

The invention concerns an ceiling electromechanical actuator for up-and-over and sectional doors. It comprises a guide profile (11), a sliding block or carriage (12) moving along the guide profile and connected to the door to be controlled, and an electrical gear motor (19) to control the opening and closing movements of the door by means of a transmission chain (13). The transmission chain (13) has one end (13′) attached to the sliding block or carriage (12), turns on said sprocket (18) driven by a gear motor (19) and returns, with a free end section (13″) in the guide profile (11) in a direction parallel to the movement of said sliding block or carriage.

### FIELD OF THE INVENTION

This invention concerns the motorised closing systems field. In particular it concerns up-and-over and sectional doors and refers especially to an electromechanical device for controlling the opening and closing of said doors.

### STATE OF THE TECHNIQUE

Control systems of motorised up-and-over and sectional doors are already well known and ceiling actuators are used which essentially include a guide profile, a sliding block or carriage moving longitudinally along the guide profile and connected to the door to be controlled, and an electrical gear motor housed in a body or casing positioned at one end of the guide profile and used to cause the alternative movements, corresponding to the opening and closing of the door by means of a chain transmission.

According to one known realisation, the chain transmission, during the backward movement of the sliding block, is collected and wound in spirals on a spool powered by the gear motor, whereas it unwinds during the forward movement of said sliding block. This coiling method for collecting the chain however, requires having a lot of free space available on the spool winder side with the implicit inconvenience of the need for a larger overall size of the body or casing housing the motor equipment.

### OBJECT AND SUMMARY OF THE INVENTION

On the other hand, one of the objectives of this invention is to avoid this drawback by eliminating the winding in spirals of the chain to successfully reduce the overall size of the actuator on the gear motor side, ensuring at the same time an improved transmission of the torque from the chain sprocket an a decrease in noise.

This objective is achieved, according to the invention, with an actuator according to the preamble of claim 1 and in which the transmission chain connected to the sliding block or carriage turns on a sprocket and has a free end section which returns and slides longitudinally in the guide profile. For this purpose, this profile, besides being a guide channel for the sliding block or carriage, is shaped so as to form, at least one additional guide channel for the return section of the chain.

At the level of the sprocket, the guide channel is defined by internal and external guide elements which form an obligatory passage for the chain, geometrically shaped to improve the meshing of the chain with the sprocket and to bring the free section, i.e. the passive section, of the chain as near as possible to the active section connected to the sliding block. In this way it is possible to reduce dimensions, therefore overall size, even more, at least as regards to the width of the guide profile.

### BRIEF DESCRIPTION OF DRAWINGS

Further details of the invention will become more evident in the continuation of this description made in reference to the enclosed, indicative and non-limiting drawings, in which:

FIG. 1 shows a perspective view of the actuator according to the invention;

FIG. 2 shows a lateral view of the actuator highlighting the gear motor equipment;

FIG. 3 shows a plan view of the actuator in FIG. 2;

FIG. 4 shows a perspective view of a part of the guide profile to highlight the chain movement;

FIG. 5 shows a perspective view of the inside of the guide group and return of the chain in a preferred realisation;

FIG. 6 shows a plan view of the group in FIG. 5; and

FIG. 7 shows a view of the group according to arrows A-A in FIG. 2.

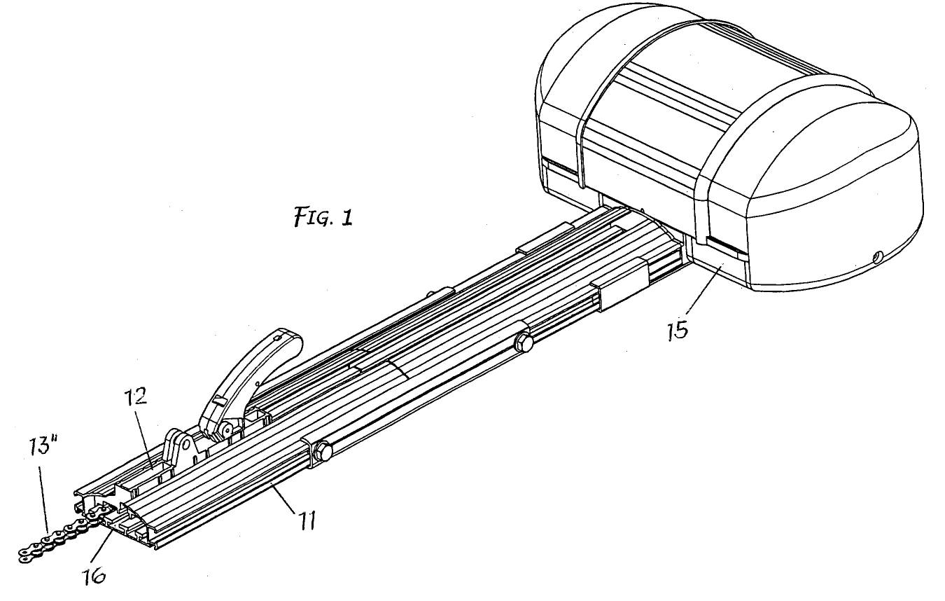

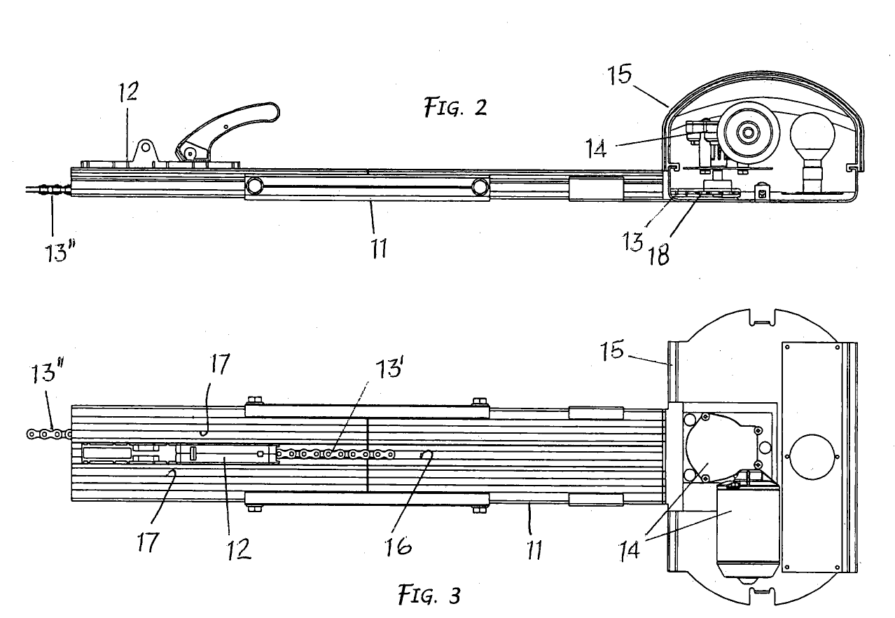

### DETAILED DESCRIPTION OF THE INVENTION

As shown, the actuator includes a guide profile 11, a sliding block or carriage 12 moved along the guide profile and connected to a transmission chain 13, and a gear motor 14 housed in a casing 15 positioned at one end of said profile.

The guide profile 11, which can advantageously be made of extruded aluminium or an aluminium alloy, has a first longitudinal guide channel 16 for the sliding block or carriage 12 and at least one other channel 17, or better two additional channels, symmetrical to the first channel 16.

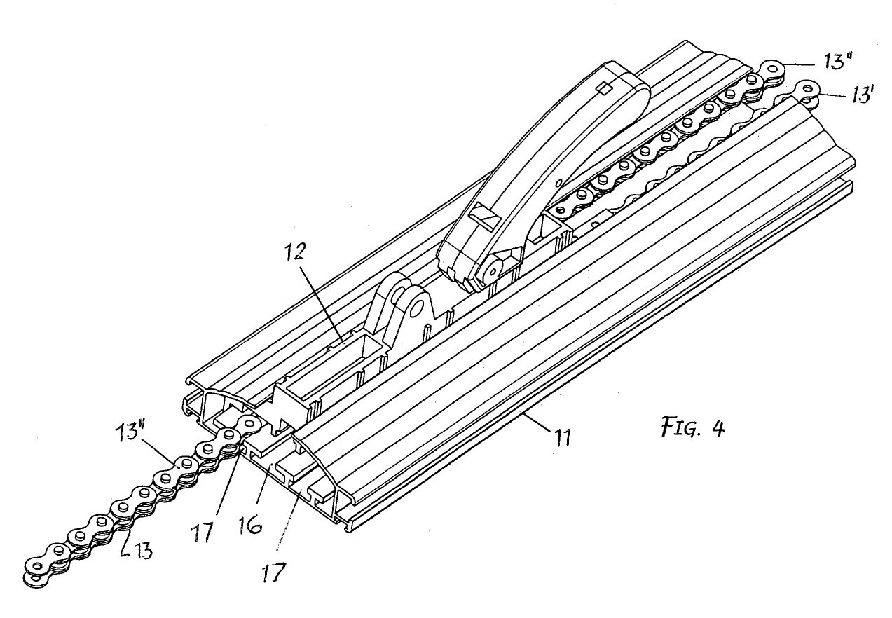

The sliding block or carriage 12 is attached, on one side, to the door—not shown—to be operated and, on the other side, to one end of an active section 13′ of the transmission chain 13. Starting from this end, the chain 13 extends in the same guide channel 16 of the sliding block or carriage 12 and turns on a sprocket 18 driven by an electrical gear motor 19 and has a passive section 13″ that returns in profile 11, guided longitudinally along one of the additional channels 17—FIG. 4.

Consequently, the gear motor 14 can control, through the sprocket and chain, the alternative shifting of the sliding block or carriage for the opening and closing movements of the door connected to it, whereas the free section 13″, i.e. the passive section, of the chain itself simply slides in the respective additional channel 17 of the profile, parallel to the sliding block or carriage 12.

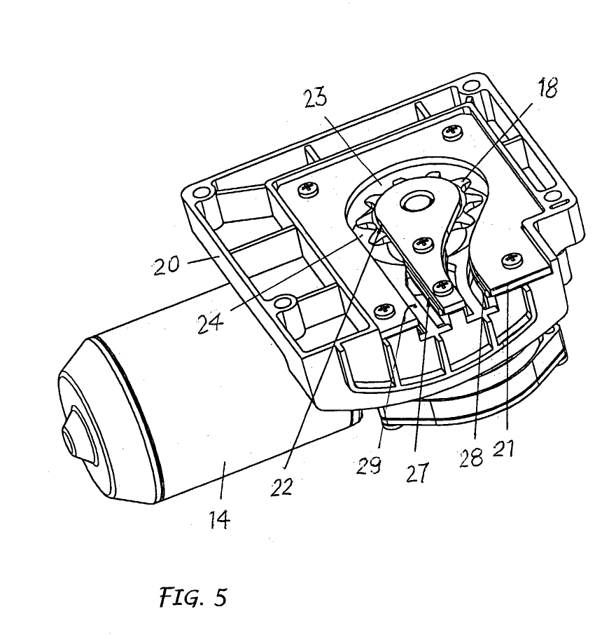

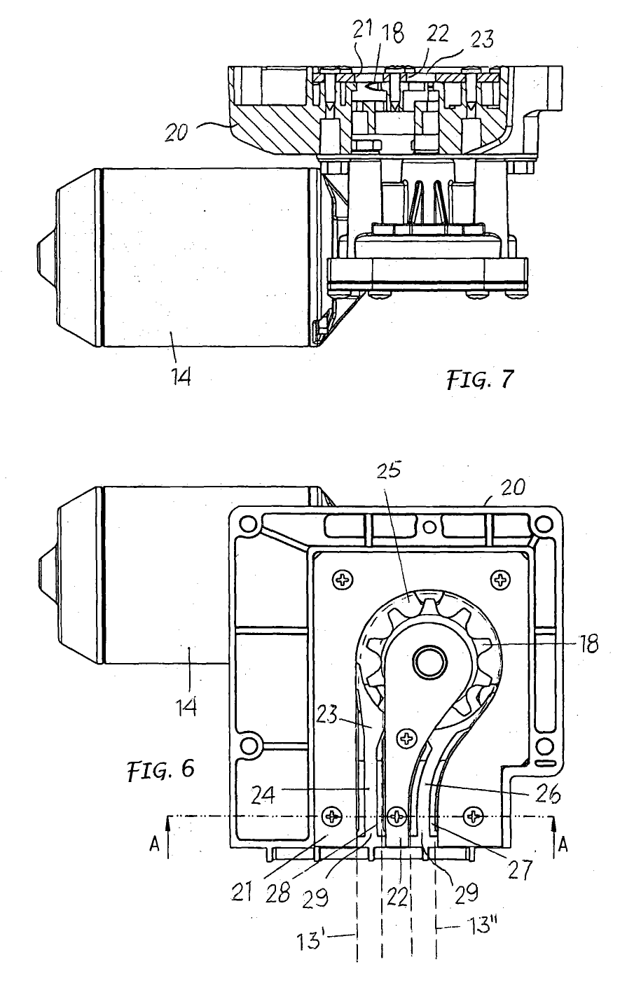

In a preferred realisation, gear motor 14 and chain 13 control sprocket 18 are assembled on a supporting body 20—FIGS. 5-7 located in the casing 15.

Within the sphere of the sprocket 18 and in association with it, are provided an external guide element 21 and an internal guide element 22 respectively outside and inside the route of the two chain sections. These guide elements are separated and between them form a guide passage 23 in which the parts of the chain 13 adjacent and passing around the sprocket 18 are obliged. The width of the guide passage 23 is compatible with the links of the chain. It has a rectilinear tract 23 at a tangent to the sprocket 18 in which the active section 13′ of the chain connected to the sliding block passes. The rectilinear section 24 of the guide passage 23 continues to form a circular part 25 which is concentric to the sprocket and which continues into a curvilinear tract 26 which leads towards the rectilinear tract 24 until it is parallel to it. The second passive section 13″ of chain 13 is now moving in this curvilinear tract 26 of the guide passage 23 and in the respective guide channel 17 of profile 11.

Along the external 21 and internal 22 guide elements, on at least one part of their sides facing passage 23 in the rectilinear 24 and curvilinear 26 tracts of this, protrusions 27, 28 project, made in the supporting body 20—FIG. 3. These protrusions 27, 28 form a tapered passage 29 on a level with the rollers of the chain with a width compatible with the diameter of the rollers themselves.

In particular, the external guide element 21 ensures, together with guide of the chain links, the correct conveyance of the latter during its travel along the various tracts of passage 23. The internal guide element 22, placed above the sprocket, helps to prevent it from jamming with the chain when turning. In the rectilinear 24 and curvilinear 26 tracts of the guide passage 23, the protrusions 27, 28 forming the tapered passage 29 facilitate the entrance of the chain as it engages with the sprocket.

Thanks to the configuration of the guide passage 23, the part of the chain travelling along the rectilinear tract 24 and where in fact the pulling force is applied, is at a tangent to the rolling pitch diameter of the sprocket, avoiding in this way a damaging curvature of the chain itself. A curvature, on the other hand has been created in the free section 13 of the chain which travels along the curvilinear tract 26 of passage 23 in order to make it come closer to the section engaged by the pulling force where such curvature of no relevance.

1. Ceiling actuator for up-and-over and sectional doors, comprising of a guide profile (11), a sliding block or carriage (12) moving longitudinally along the guide profile and connected to the door to be controlled, and an electrical gear motor (19) housed in a body or casing positioned at one end of the guide profile and used to control a sprocket (12) to cause the alternative movements of the sliding block or carriage corresponding to the opening and closing movements of the door by means of a transmission chain (13), characterised by the fact that the transmission chain (13) has an active section (13′) with one end attached to the sliding block or carriage (12) and turns on said sprocket (18) driven by a gear motor (19), and a passive section (13″) returning in profile (11) in a direction parallel to the movement of said sliding block or carriage.

2. Ceiling actuator according to claim 1, wherein said guide profile 11 has a longitudinal first guide channel (16) for the sliding block or carriage (12) and the chain attached to it, and at least a second channel (17) to receive and guide the free end section (13″) of said chain.

3. Ceiling actuator according to claims 1 and 2, wherein said guide profile (11) has two additional channels (17) placed symmetrically and parallel to the guide channel of the sliding block or carriage.

4. Ceiling actuator according to claim 1, characterised by the fact that it includes, in association with said sprocket (18), external and internal (21,22) guide fixtures, forming an obligatory passage (23) for the transmission chain (13) and configured to direct the active section (13′) of the chain connected to the sliding block or carriage, at a tangent to the control sprocket and to move the passive free end (13″) of the chain close to and parallel with said active section.

5. Ceiling actuator according to claim 4, wherein said guide fixtures include an external guide element (21) and an internal guide element (22) positioned respectively outside and inside the route of the two active and passive (13′, 13″) sections of the chain, separated and forming between them the guide passage (23) in which the adjacent parts of the chain are housed and pass around the sprocket (18), the width of the guide passage (23) being compatible with the dimensions of the links of the chain and presenting, in succession, a rectilinear tract (24) at a tangent to the sprocket (18) and along which moves the active section (13′) of the chain connected to the sliding block, an intermediate circular part (25) concentric to the sprocket (18) and a curvilinear tract (26) which leads to the rectilinear tract (24) until it is parallel to it and in which the passive section (13″) of the chain moves.

6. Ceiling actuator according to claim 5, wherein said external and internal guide elements (21,22) are placed in a supporting body (20) housing the sprocket and control gear motor, and wherein along at least one part of the internal sides of the rectilinear (24) and curvilinear (26) tracts of said guide passage (23), protrusions (27, 28) are provided which form between them, a tapered passage (29) on a level with the rollers of the chain and whose width is compatible with the diameter of said rollers.

7. Ceiling actuator according to claim 6, wherein said protrusions (27, 28) are made in the supporting body (20) of the sprocket (18).

8. Ceiling actuator for up-and-over and sectional doors, comprising a guide profile (11), a sliding block or carriage (12) moving longitudinally along the guide profile and connected to the door to be controlled, and an electrical gear motor (19) housed in a body or casing positioned at one end of the guide profile (11) and used to control a sprocket (12) to cause the alternative movements of the sliding block or carriage corresponding to the opening and closing movements of the door by means of a transmission chain (13), characterised by the fact that the transmission chain (13) has an active section (13′) with one end attached to the sliding block or carriage (12) and turns on said sprocket (18) driven by a gear motor (19), and a passive section (13″), returning in profile (11) in a direction parallel to the movement of said sliding block or carriage, and in that, in association with said sprocket (18), external and internal guide fixtures (21, 22) are provided forming an obligatory passage (23) for the transmission chain (13), shaped to direct the active section (13′) of the chain connected to the sliding block at a tangent to the control sprocket and to get the passive section of the free end (13″) of the chain to approach and be parallel to said active section.
